(19) United States
(12) Patent Application Publication
(10) Pub. No.: US 2008/0023892 A1
(43) Pub. Date: Jan. 31, 2008

(54) Device and Method for Heat Treating, in Particular, Metallic Workpieces

(75) Inventors: Bernd Edenhofer, Kleve (DE); Thomas Paryjas, Hunxe (DE)

Correspondence Address: JONES & SMITH, LLP, 2777 ALLEN PARKWAY, SUITE 800, HOUSTON, TX, 77019-2141, US

(73) Assignee: Ipsen International GmbH

(21) Appl. No.: 10/579,218

(22) PCT Filed: Sep. 11, 2004
(86) PCT No.: PCT/EP04/10176

§ 371 Date: Apr. 27, 2007

(30) Foreign Application Priority Data
Nov. 14, 2003 (EP) 03026214.1

(51) Int. Cl. C21D 1/74; F27D 1/18

(52) U.S. Cl. 266/249; 432/250

(57) ABSTRACT

The invention relates to a horizontal atmospheric furnace for heat treating, in particular, metallic workpieces at high temperatures. In order to crate a furnace that, while having a simple design and being easy to operate at the same time, enables a transfer of heat-treated workpieces into a quenching device while concluding the atmosphere surrounding the furnace, the invention provides that a horizontal atmospheric furnace for heat treating, in particular, metallic work pieces at high temperatures with a preferably cylindrical furnace chamber and with a furnace door that closes the furnace chamber in a gas-tight manner. Said furnace door is mounted in a manner that enables it to be displaced inside a door case. Which forms a lock that can be closed in a gas-tight manner.

The invention relates to a device in form of an atmospheric furnace for thermal treatment of in particular metallic workpieces at high temperatures. The invention also relates to a method for thermal treatment of in particular metallic workpieces in such a furnace.

Furnaces of the above mentioned type have been used so far as so called shaft furnaces presenting a vertical structure. However, a drawback of a shaft furnace is that after a thermal treatment of the metallic workpieces, these ones have to be taken out of the shaft furnace by means of a lifting tool and have to be moved into a quenching bath juxtaposed to the shaft furnace. During this transfer operation, an oxidation of the heat treated workpieces will be disadvantageously provoked due to the contact of the heat treated workpieces with the ambient air, which as a consequence leads to a skin decarburization and a quality loss related therewith.

For overcoming the above described drawbacks, horizontal multiple box furnaces have been known from the state of the art, which have an integrated quenching bath, such that both the thermal treatment and the quenching operation can be carried out in protective furnace gas. However, a drawback of such a multipurpose box furnace is that quenching bath and furnace are directly related to each other, whereby the device as such is very inflexible with regard to quenching in different media. The utilization ratio of the quenching bath integrated in the multipurpose box furnace is also very low and is mostly no more than 10% to 20%, since the cycle time of the heating and the thermal treatment is in most cases a multiple of the cycle time of the quenching.

In order to increase the quenching flexibility, the so called vertical bell furnace system has been developed. In this system the bell shaped top hat furnaces are arranged displaceable on rails and can be moved back and forward above correspondingly formed quenching baths. After a thermal treatment of the workpieces in the furnace, these ones including the bell shaped furnace can be placed above a corresponding quenching bath, such that in contrast to the above described multiple box furnace a flexible quenching becomes possible. Herein, the quenching is carried out by approaching the opening of the bell shaped furnace as closely as possible to the upper opening of the quenching bath, wherein the narrow intermediate gap that is produced herein between quenching bath on the one hand and opening of the bell shaped furnace on the other hand is swept with nitrogen in order to prevent an undesired oxidation of the heat treated workpieces. However, a completely gas tight coupling of the quenching bath is not possible, such that a completely oxide free thermal treatment cannot be achieved, even if a bell furnace system is used.

Based upon the above described state of the art, it is the object of the invention to provide a furnace for the thermal treatment of in particular metallic workpieces which, while avoiding the above mentioned drawbacks and while having a simple design and being easy to operate at the same time, enables a transfer of heat treated workpieces into a quenching chamber while excluding the atmosphere surrounding the furnace.

This aim is achieved by a furnace, in particular for the thermal treatment of metallic workpieces at high temperatures, which is a horizontal atmospheric furnace and comprises a preferably cylindrical furnace chamber as well as a furnace door that closes the furnace chamber in a gas-tight manner, wherein the furnace door is mounted in a displaceable manner within a door case that forms a lock which can be closed in a gas-tight manner.

High temperatures in the sense of the invention are temperatures comprised between more than 400° C. and 1.050° C.

The furnace according to the invention in particular stands out for its furnace door that closes in a gas-tight manner on the one hand and for the door case forming the lock on the other hand. Due to these structural components the horizontal atmospheric furnace can be coupled in a gas-tight manner to counter-modules which are for example formed as transport modules. The workpieces that have been submitted to a thermal treatment can thus be removed from the furnace and transferred into the counter-module while excluding the atmosphere surrounding the furnace. Since a complete sealing between the furnace on the one hand and the counter-module on the other hand can be assured by means of the door case, an undesired oxidation of the thermally treated workpieces can be safely excluded. The design according to the invention permits to couple the furnace formed as horizontal atmospheric furnace in a gas-tight manner to a counter-module formed as transport module. Hereby it is achieved that heated workpieces can be transported to different quenching modules via the transport module without any oxidation and can be quenched there in protective furnace gas without oxidation. The quenching operation can thus be completely decoupled from the thermal treatment operation in the furnace, such that the furnace according to the invention is highly flexible with regard to different quenching possibilities.

With respect to the longitudinal extension of the furnace, the furnace door is arranged in the door case such that it is preferably displaceable in a vertical direction. Herein, the door case that forms the lock is gas-tightly closed and makes a volume available which can be determined with regard to the size and which can be flooded with protective furnace gas according to the needs. On the side opposite the furnace chamber, the door case preferably comprises means for a gas-tight connection of the door case to a correspondingly formed counter-module. Such a counter-module serves for loading and unloading the furnace according to the invention, wherein due to the above described design of the door case, a gas-tight arrangement of the furnace on the one hand and the counter-module on the other hand can be safely achieved. As the furnace, the counter-module is preferably heat insulated and gas-tight, such that it can transfer a workpiece to be thermally treated into the furnace according to the invention or receive an already thermally treated workpiece from the furnace while excluding the atmosphere surrounding the furnace installation.

Herein, the loading of the furnace according to the invention by using a counter-module can be realized as described in the following: The furnace according to the invention, which is also called box furnace, having the furnace door closed, being supplied with process gas and being set to working temperature, is ready for the treatment of the workpieces to be thermally treated. The cold counter-module which is loaded with the workpieces to be thermally treated is coupled to the furnace. For this purpose, corresponding clamping means can be provided at the furnace, which after a coupling obviate a relative displacement between furnace and counter-module. Due to the coupling a lock chamber formed by the door case of the furnace is formed between furnace door on the one hand and counter-module door on the other hand. In this position, the furnace and the counter-module form a firm unit. In the following, the door of the counter-module is opened whereby a common chamber formed by the lock and the counter-module interior is formed. The thus formed chamber is flooded with nitrogen for sweeping, wherein it can be provided that either the door case of the furnace and/or the counter-module has a corresponding inlet for supply with nitrogen. The counter-module can also be already filled with nitrogen, such that then only the air has to be swept out of the lock chamber before the two doors will be opened. During sweeping the nitrogen is blown out via an outflow that is preferably placed at the door case of the furnace. After that, the furnace door of the furnace can be opened and the batch of workpieces to be treated that is present in the counter-module can be transferred into the furnace chamber of the furnace. For this purpose, a push-pull chain can be provided at the counter-module, by use of which the transport device that carries the workpieces to be treated can be moved out of the counter-module into the furnace chamber of the furnace. As soon as the batch to be thermally treated has been placed in the furnace chamber of the furnace, both the furnace door of the furnace and the door of the counter-module are closed again. Then, counter-module and furnace can be again decoupled from each other and the counter-module will be available for other transports. Within the furnace, the thermochemical treatment of the batch will now take place.

For unloading the furnace according to the invention the above described operation has to be carried out in reverse order: The counter-module set to temperature and filled with protective furnace gas is coupled to the furnace according to the invention. For neutralization the air is swept out of the lock chamber formed between furnace and counter-module with protective gas. Then, the furnace door of the furnace and the door of the counter-module are opened and the thermally treated batch is transferred from the furnace chamber into the counter-module by means of the push-pull chain of the counter-module. Both the furnace door and the door of the counter-module are then closed. As soon as the counter-module is decoupled from the furnace, the thermally treated workpieces, which still have a certain temperature, can be transported from the counter-module to a correspondingly formed quenching module.

The atmospheric furnace according to the invention can work with nitrogen but also with combustible or partially toxic gases. Therefore, the thermally treated batch can possibly not be transported in furnace atmosphere. It is rather necessary to sweep the furnace atmosphere out with an inert protective gas before transferring the batch from the furnace into the transport module, wherein this protective gas can be discharged via a corresponding exhaust gas pipe of the furnace with burning off. Accordingly, also before a batch transfer, the air is swept out of the lock chamber formed by the door case of the furnace with an inert gas via a waste gas means in the door case. As soon as the sweeping operation has been successfully completed, the thermally treated batch can be transferred without any danger into the counter-module that is for example a transport module while excluding the atmosphere surrounding the furnace and can in the following be submitted to a quenching treatment. In case of a combustible furnace atmosphere, this one is swept out already in the furnace either shortly before a workpiece is placed into the counter-module or only in the counter-module shortly before the transfer of the workpieces for example into a quenching chamber.

Furthermore, the furnace according to the invention stands out for the simple structure thereof. It essentially consists of a cylindrical furnace chamber within which bar-shaped heating elements are arranged for heating up the furnace chamber atmosphere. For circulating the furnace chamber atmosphere, the furnace chamber has a gas circulation device on the face, which is preferably a ventilator. For the purpose of free accessibility the ventilator is driven by a motor that is placed outside the furnace chamber. It is the purpose of the gas circulation device to circulate the furnace atmosphere present in the furnace chamber according to the needs within the scope of a thermal treatment process. Herein, the intensity of the gas circulation can be optionally influenced depending on the rotation speed of the gas circulation device in form of a ventilator.

Parallel to the axis of the longitudinal extension of the furnace chamber, bar-shaped heating elements are provided within the furnace chamber, which are arranged in the way of a drum turret with respect to the gas circulation device. This type of arrangement of the heating elements assures that a workpiece which is present in the furnace chamber or a workpiece batch composed of several workpieces will be uniformly heated. Hereby, reproducible heat treating methods can be carried out in an especially simple way.

The workpieces to be thermally treated are moved into the furnace chamber preferably by means of a transport device that can be displaced on rails in the longitudinal direction of the furnace chamber. If the transport device is in its final position inside the furnace chamber for the purpose of a thermal treatment, the workpieces placed on the transport device are located within the treatment zone that is encompassed by the heating elements arranged in the way of a drum turret. This kind of design enables a uniform heating from all sides of the workpieces placed within the furnace chamber.

The advantages of the furnace according to the invention in particular result from the simple structure thereof. For loading and unloading, the furnace only has one door, which is placed inside a door case that forms a lock, such that workpieces can both be placed into the furnace and be removed from this one while excluding the atmosphere surrounding the furnace. The furnace chamber has a cylindrical form, which advantageously serves for the uniform thermal treatment of the workpieces arranged within the furnace. The gas circulation device that is preferably a ventilator is surrounded by the heating elements arranged in the form of a drum turret, such that a uniform circulation of the furnace atmosphere can be carried out with respect to the workpieces to be thermally treated. Furthermore, the furnace according to the invention permits an optimized integration into a module park that is formed by several furnaces, which can be respectively reached by a correspondingly formed counter-module for loading and/or unloading. In so far, the furnace stands out for its high flexibility in connection with other treatment chambers. Furthermore, the furnace according to the invention requires few maintenance and repair works due to the comparatively simple structure thereof.

With respect to the method, the invention proposes a method for the thermal treatment of in particular metallic workpieces in a horizontal atmospheric furnace, in which the workpieces to be thermally treated are supplied to the atmospheric box furnace by means of a transport chamber that is arranged in a relatively displaceable manner with respect to the atmospheric box furnace, wherein
in a first step, the transport chamber that is eventually filled with protective gas is coupled in a gas-tight manner to the door case of the atmospheric box furnace,
in a second step, the volume space encapsulated by the door case as well as, if necessary, the transport chamber are swept with protective gas,
in a third step, the workpieces to be thermally treated are transferred from the transport chamber into the atmospheric box furnace in protective gas atmosphere and
finally in a fourth step, the workpieces that have been transferred into the atmospheric box furnace are thermally treated in protective gas.

The above described method advantageously permits a thermal treatment without any oxidation, since the workpieces to be thermally treated are kept in protective gas in the course of the entire execution of the method. An undesired oxidation of the workpieces can thus be safely avoided.

After a transfer of the workpieces to be thermally treated from the transport chamber into the atmospheric box furnace, the transport chamber can be used differently, whereby a high flexibility of the entire thermal treatment installation is achieved.

After having completed the thermal treatment, the workpieces can be transferred into a quenching chamber for the purpose of quenching. In this connection, the invention proposes a method which is characterized in that after completion of a thermal treatment the workpieces are supplied to a quenching chamber by means of the transport chamber, wherein
in a first step, the thermally treated workpieces are transferred in protective gas from the atmospheric box furnace into the transport chamber that has been coupled in a gas-tight manner to the atmospheric box furnace,
in a second step, the transport chamber and the atmospheric box furnace are closed in a gas-tight manner,
in a third step, the volume space formed by the door case, is swept with nitrogen gas,
in a fourth step, the transport chamber is decoupled from the atmospheric box furnace,
in a fifth step, the transport chamber is displaced towards the quenching chamber and coupled in a gas-tight manner to the quenching chamber,
in a sixth step, the air is swept out of the volume space formed by the door case between transport chamber and quenching chamber with nitrogen gas,
in a seventh step, the workpieces are transferred in protective gas from the transport chamber into the quenching chamber after opening the doors of both chambers and
finally in an eighth step, the workpieces that have been transferred into the quenching chamber are quenched after closing the doors of the two chambers.

According to the above described method, the thermally treated workpieces are transferred from the atmospheric box furnace into the quenching chamber also in protective gas. The entire operation of the thermal treatment including the quenching step can thus be advantageously carried out while excluding the atmosphere surrounding the installation. The entire thermal treatment process takes thus place without any oxidation with simultaneous flexibility of the individual components of the installation.

According to another characteristic of the method, the invention proposes that after completion of the thermal treatment the thermally treated workpieces are transferred from the atmospheric box furnace into the transport chamber, wherein in case of the use of a combustible protective gas atmosphere in the atmospheric box furnace, this one is removed with a non-combustible protective gas either by sweeping the atmospheric box furnace shortly before a transfer of the workpieces into the transport chamber or by sweeping the transport chamber after a transfer of the workpieces into the transport chamber. This process step is in particular advantageous if a thermal treatment of the workpieces was carried out in the atmospheric box furnace in combustible protective gas atmosphere. By sweeping the atmospheric box furnace or the transport chamber with a for example inert protective gas, the combustible protective gas atmosphere can thus be swept out of the atmospheric box furnace or the transport chamber. Accordingly, after each coupling the lock space (door case) between both chambers has to be swept free of air (with nitrogen) in the same way as the combustible furnace atmosphere has to be removed from the lock space (door case) by sweeping with nitrogen before each decoupling from the atmospheric box furnace.

Other characteristics and advantages of the invention will result from the description made with reference to the following figures. Herein:

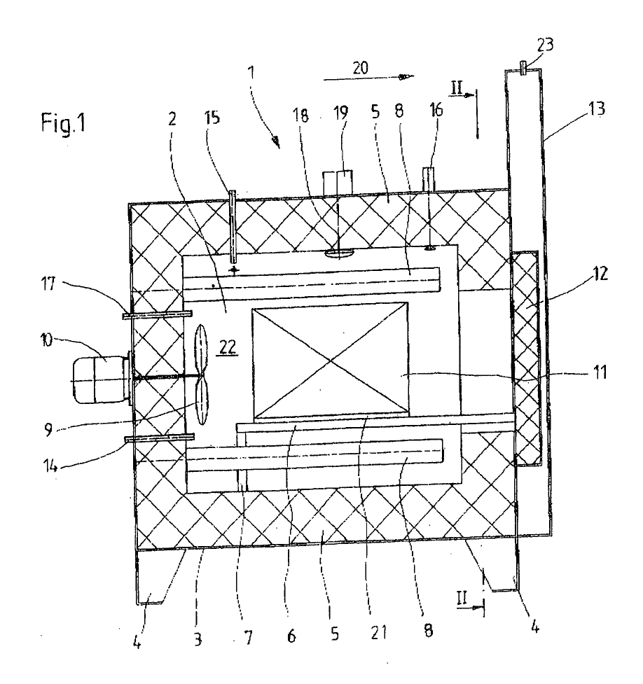

FIG. 1 shows a schematic cut side view of the furnace according to the invention according to a preferred embodiment and

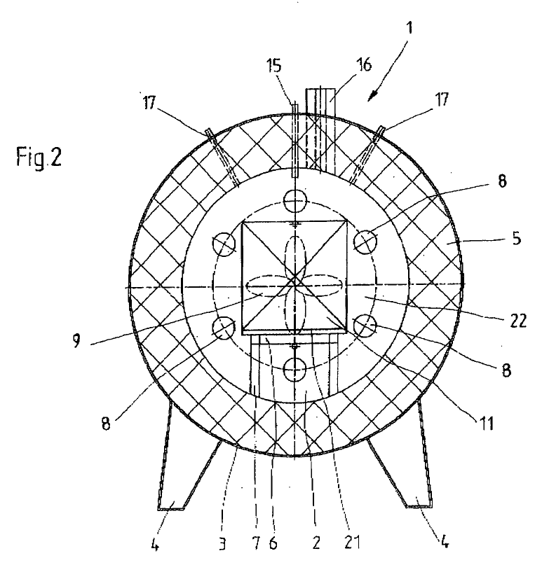

FIG. 2 shows the furnace according to the invention in a view cut along the cutting line II-II in FIG. 1.

FIGS. 1 and 2 show the furnace according to the invention in a preferred embodiment. This one is not limiting and only serves for the exemplary detailed explanation of the functioning. The same parts in FIGS. 1 and 2 are identified by the same reference numerals.

The furnace 1 is composed of a steel housing 3, which has correspondingly formed bases 4 for a safe standing. Within the steel housing 3, the furnace chamber 2 is formed which has an insulation 5 arranged at the inner side of the steel housing 3 for a heat insulation.

For circulating the furnace chamber atmosphere, a gas circulation device in form of a ventilator 9 is arranged inside the furnace chamber 2. The ventilator 9 is driven by a motor 10 which is accessible from outside and is placed outside the furnace chamber 2. With regard to the driving, the motor 10 and the ventilator 9 are connected to each other via a no further referenced driving shaft.

The heating elements 8 formed within the furnace chamber 2 serve for the thermal treatment of a batch 11 placed inside the furnace chamber 2. The heating elements 8 are bar-shaped and extend in the longitudinal direction 20 of the furnace chamber 2. As in particular visible in FIG. 2, the totally six heating elements 8 are placed with respect to the ventilator 9 in the way of a drum turret and thus form a treatment zone 22 that is schematically represented in FIG. 2.

For carrying out a thermal treatment, the batch 11 to be thermally treated is preferably placed in the centre within the treatment zone 22. It is an advantage of this arrangement that the individual workpieces of the batch 11 are uniformly provided with heat generated by the heating elements 8, which permits the execution of a reproducible thermal treatment process.

The batch 11 is supported by a transport device 21 which is placed on rails 6 which in turn rest upon the stand 7. The transport device can be preferably displaced in the longitudinal direction 20.

The furnace chamber 2 on the face and opposite the ventilator 9 is provided with a loading and unloading opening which can be optionally opened or closed by means of a furnace door 12 that closes the chamber in a gas-tight manner. Herein, the furnace door 12 is mounted inside a door case 13 that forms a lock and within which the furnace door 12 can be displaced in the vertical direction of the door case 13. FIG. 1 shows the furnace door 12 in a position closing the loading and unloading opening of the furnace.

For creating an optionally desired furnace atmosphere, the furnace chamber 2 has a process gas supply 14 preferably on the face. Furthermore, a protective gas supply 15 can be provided, via which for example nitrogen can be introduced into the furnace chamber 2. For checking the furnace atmosphere set in the furnace chamber 2, also measuring instruments 17 can be provided.

In the case of an overpressure inside the furnace chamber 2, this one can be relieved according to the needs by means of an only schematically represented opening 18 that is closed by a pressure compensation valve. The pressure compensation valve preferably has an integrated tearing film, such that under critical overpressure conditions a corresponding pressure compensation will be automatically realized. The furnace also has a burning-off means 16 via which process gas that is present in the furnace chamber 2 can be burnt off in case of need.

It a special advantage of the furnace according to the invention that this one can be coupled in a gas-tight manner to a counter-module, for example in the form of a transport module, by means of the door case 13 that forms a gas-tight lock. Thus, while excluding the atmosphere surrounding the furnace, heated batches can be transferred from the furnace into the counter-module or from the counter-module into the furnace without any oxidation. The furnace according to the invention is operated for example by using combustible or also toxic gases, such as for example CO, such that it may be required for the transfer of a batch into the counter-module to previously sweep the atmospheric furnace with an inert protective gas, wherein the protective gas is discharged via a corresponding furnace gas pipe with burning-off. Accordingly, air is also previously swept out of the lock space of the door case 13 with an inert gas via a discharge means 23 in the door case 13.

### List of Reference Numerals

1 furnace
2 furnace chamber
3 steel housing
4 base
5 insulation
6 rail
7 stand
8 heating element
9 ventilator
10 motor
11 batch
12 furnace door
13 doorcase
14 process gas supply
15 protective gas supply
16 burning-off means
17 measuring instrument
18 opening
19 pressure compensation valve
20 longitudinal direction
21 transport device
22 treatment zone
23 discharge means

1. A horizontal atmospheric furnace, in particular for the thermal treatment of metallic workpieces at high temperatures, comprising a preferably cylindrical furnace chamber and a furnace door (12) for closing the furnace chamber in a gas-tight manner, wherein the furnace door is mounted in a displaceable manner within a door case that forms a lock capable of being closed in a gas-tight manner.

2. The horizontal atmospheric furnace according to claim 1, wherein the door case comprises a gas-tight connection to a correspondingly formed counter-module.

3. The horizontal atmospheric furnace according to claim 1, wherein the furnace door is displaced vertically with respect to the longitudinal direction of the furnace chamber.

4. The horizontal atmospheric furnace according to claim 1, wherein the thermal treatment is conducted at a temperature between from about 400° C. to about 1050° C.

5. The horizontal atmospheric furnace according to claim 1, wherein the door case comprises a gas discharge port.

6. The horizontal atmospheric furnace according to claim 1, wherein the furnace chamber comprises gas inlets formed in the furnace chamber wall.

7. The The horizontal atmospheric furnace according to claim 1, further comprising a ventilator inside the furnace chamber.

8. The horizontal atmospheric furnace according to claim 1, further comprising a multitude of heating elements that extend in the longitudinal direction of said furnace chamber and form a treatment zone.

9. The horizontal atmospheric furnace according to claim 1, wherein the ventilator is driven by a motor, wherein the drive unit of the ventilator is placed outside said furnace chamber.

10. The horizontal atmospheric furnace according to claim 1, further comprising a transport arranged inside the furnace chamber for receiving the workpiece wherein the transport is capable of being displaced on rails in the longitudinal direction of said furnace chamber.

11. A method for the thermal treatment of a metallic workpiece in a horizontal atmospheric furnace, wherein the workpiece to be thermally treated is supplied to the atmospheric furnace by a transport chamber which is arranged in a displaceable manner with respect to the atmospheric box furnace, wherein:
(A) coupling the transport chamber, which is ultimately filled with protective gas, in a gas-tight manner to the door case of the atmospheric furnace,
(B) sweeping the volume space encapsulated by the door case as and, optionally, the transport chamber with a protective gas,
(C) transferring the workpiece desired to be thermally treated from the transport chamber into the atmospheric box furnace in protective gas atmosphere and
(D) thermally treating the workpiece transferred into the atmospheric box furnace in protective gas.

12. The method according to claim 11, wherein, subsequent to step (D), the workpiece is supplied to a quenching chamber by the transport chamber, wherein
(E) the thermally treated is transferred in protective gas from the atmospheric box furnace into the transport chamber, the transport chamber having been coupled in a gas-tight manner to the atmospheric box furnace,
(F) closing the transport chamber and the atmospheric box furnace in a gas-tight manner,
(G) sweeping the volume space formed by the door case with nitrogen gas,
(H) decoupling the transport chamber from the atmospheric box furnace,
(I) displacing the transport chamber towards the quenching chamber and coupling the transport chamber in a gas-tight manner to the quenching chamber,
(J) sweeping the air out of the volume space formed by the door case between transport chamber and quenching chamber with nitrogen gas,
(K) transferring the workpiece in protective gas from the transport chamber into the quenching chamber after opening the doors of both chambers and
(L) quenching the workpiece after closing the doors of the two chambers.

13. The method according to claim 12, wherein the atmospheric box furnace is swept with protective gas before a transfer of the workpiece into the transport chamber.

14. The method according to claim 12, wherein the transport chamber is swept with protective gas after a transfer of the workpiece into the transport chamber.

15. The horizontal atmospheric furnace according to claim 6, wherein the furnace chamber further comprises a combustion means.
